(19) United States
(12) Patent Application Publication
(10) Pub. No.: US 2012/0327748 A1
(43) Pub. Date: Dec. 27, 2012

(54) SMART WAKING DEVICE AND SMART WAKING METHOD THEREOF

(76) Inventor: Chung-Ping Lee, Taoyuan County (TW)

(21) Appl. No.: 13/226,997

(22) Filed: Sep. 7, 2011

(30) Foreign Application Priority Data
Jun. 21, 2011 (TW) 100121718

(51) Int. Cl. G04G 21/02

(52) U.S. Cl. 368/11

(57) ABSTRACT

The present invention discloses a smart waking device and a smart waking method thereof. The smart waking device comprises: a detection unit, a setting unit, a waking unit and a processing module. The detection unit detects user's motion. The setting unit sets a first predetermined time. The waking unit issues a waking message. The processing module is electrically connected with the detection unit, the setting unit and the wakening unit. Based upon the first predetermined time, the processing module takes a time interval starting from the first predetermined time. While the detection unit detects the user's motion during the time interval, the processing module controls the waking unit to issue the waking message.

### CROSS-REFERENCE TO RELATED APPLICATION

This application claims the benefit of Taiwan Patent Application No. 100121718, filed on Jun. 21, 2011, in the Taiwan Intellectual Property Office, the disclosure of which is incorporated herein by reference

### BACKGROUND OF THE INVENTION

1. Field of the Invention

The present invention relates to a smart waking device and a smart waking method thereof, in particular to the device and method for waking up a user by the user's sleeping depth cycle.

2. Description of the Related Art

Nowadays, people are used to stay up late due to their busy work and often oversleep by unconsciously turning off the alarm clock set before night or disturb others' sleeping by letting the alarm ring for too long without turning it off at all.

At present, most electronic devices provide a waking function, and users can set a waking time in advance, so that when the set time comes, the electronic device will issue a waking message. Now, the user usually presses any press key or a specific press key of the electronic device to turn off the alarm. However, our sleep is periodical according to human physiological characteristics, and we go through switches between deep sleep and light sleep several times every night. When the electronic device compulsorily pulls a user from a deep sleep back to a wake-up status, the user's body cannot adapt the wake-up status appropriately, so that the user may feel very tired spiritually and physically after the user gets up. On the other hand, if the electronic device carries out the waking motion while the user is at a light sleep, the user will be more sober and agile than the conditions of waking up from a deep sleep.

However, the electronic alarm clock or other programmed electronic device still cannot wake a user according to the user's depth of sleep or the user's sleeping cycle, therefore it is an urgent and important subject for related manufacturers to design and provide a smart waking device and s smart waking method thereof.

In view of the aforementioned drawbacks of the conventional electronic alarm clock, the inventor of the present invention designed a smart waking device and a smart waking method thereof to overcome the drawbacks of the prior art.

### SUMMARY OF THE INVENTION

In view of an objective of the present invention, it is to provide a smart waking device and a smart waking method thereof to overcome the deficiency of the waking function of a conventional electronic device.

Another objective of the present invention is to provide a smart waking device, comprising: a detection unit, a setting unit, a waking unit and a processing module. Wherein, the detection unit is provided for detecting a user's motion. The setting unit is provided for setting a first predetermined time. The waking unit is provided for issuing a waking message. The processing module is electrically coupled to detection unit, the setting unit and the waking unit, and the processing module adopts the first predetermined time as a base for retrieving a predetermined time interval ahead. When the detection unit detects a user's motion during the predetermined time interval, the processing module will control the waking unit to issue a waking message.

In an embodiment, after the setting unit sets the first predetermined time, the processing module controls the detection unit to test whether or not the user's motion is detected normally.

In an embodiment, if the detection unit detects that the motion amplitude or the motion frequency of the user is greater than or equal to a preset value during the predetermined time interval, the processing module will control the waking unit to issue a waking message.

In an embodiment, the setting unit sets the preset value.

In an embodiment, the smart waking device further comprises a display unit provided for displaying the first predetermined time, the predetermined time interval and the preset value.

In an embodiment, the smart waking device further comprises at least one press button provided for setting the first predetermined time, the predetermined time interval and the preset value in the setting unit.

In an embodiment, the waking message is a sound, a light, a vibration or their combinations thereof.

In an embodiment, the smart waking device further comprises an electric power unit supplying the electric power required by the smart waking device.

In an embodiment, the smart waking device further comprises a snooze switch provided for a user to pause the waking message to a second predetermined time, and then the waking unit will issue the waking message again.

In an embodiment, the smart waking device further comprises a stop switch provided for a user to stop the waking unit issuing a waking message.

In addition, to achieve the aforementioned objective, the present invention further provides a smart waking method, comprising the steps of: setting a first predetermined time by a setting unit; detecting a user's motion by using a detection unit; issuing a waking message through a waking unit; using the first predetermined time as a base by a processing module to retrieve a predetermined time interval ahead; and controlling the waking unit by the processing module to issue the waking message while the detection unit detects the user's motion during the predetermined time interval.

In an embodiment, after using the setting unit to set the first predetermined time, the processing module controls the detection unit to test whether the user's motion is detected normally.

In an embodiment, while the detection unit detects that the motion amplitude or the motion frequency of the user is greater than or equal to a preset value during the predetermined time interval, the processing module will control the waking unit to issue the waking message.

In an embodiment, the setting unit is provided for setting the preset value.

In an embodiment, the smart waking method further comprises the step of setting the first predetermined time, the predetermined time interval and the preset value in the setting unit by at least one press button.

In summation, the smart waking device and method of the present invention have one or more of the following advantages:

(1) The smart waking device and the smart waking method thereof can detect the user's motion during the predetermined time interval by the detection unit to achieve the functions of waking the user and enhancing quality of the user's soberness.

(2) The smart waking device and the smart waking method thereof can wake the user according to the user's physiological characteristics to improve life quality.

(3) The smart waking device and the smart waking method thereof provide a snooze switch for the user to carry out the snooze function depending on the user's physical condition, so as to improve the user's physical wake-up status.

### BRIEF DESCRIPTION OF THE DRAWINGS

FIG. 1 is a block diagram of a smart waking device in accordance with a first preferred embodiment of the present invention;

FIG. 2 is a schematic view of a smart waking device in accordance with the first preferred embodiment of the present invention;

FIG. 3 is a schematic view of smart waking device in accordance with a second preferred embodiment of the present invention;

FIG. 4 is a step diagram of a procedure of a smart waking method in accordance with the present invention; and

FIG. 5 is a flow chart of a smart waking method in accordance with the present invention.

### DESCRIPTION OF THE PREFERRED EMBODIMENTS

The technical characteristics and effects of the smart waking device and smart waking method thereof in accordance with the present invention will become apparent by the detailed description of preferred embodiments and the illustration of related drawings as follows. For simplicity, same numerals are used for representing respective elements respectively in the following preferred embodiments and drawings.

The smart waking device of the present invention can be a portable electronic device with a timing function such as a clock, an alarm clock, an electronic alarm clock or a digital countdown timer. For simplicity, the electronic alarm clock is used as an example for illustrating the technical characteristics of the present invention, but the present invention is not limited to the electronic alarm clock only.

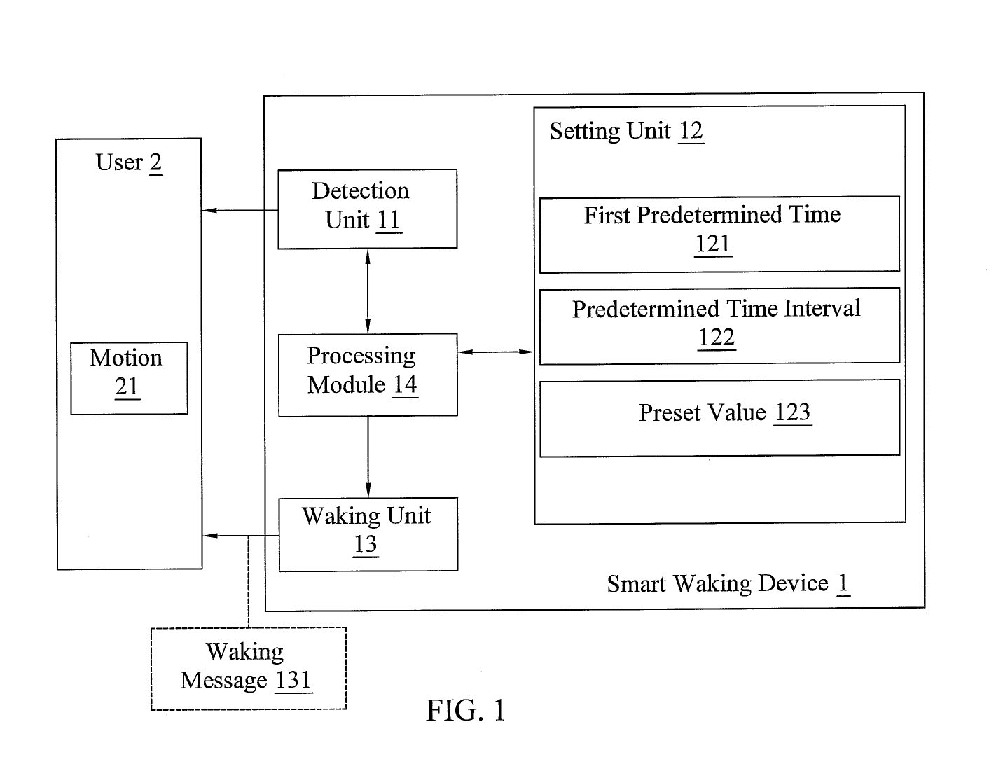

With reference to FIG. 1 for a block diagram of a smart waking device in accordance with the first preferred embodiment of the present invention, the smart waking device comprises a detection unit 11, a setting unit 12, a waking unit 13 and a processing module 14. The detection unit 11 is provided for detecting a motion 21 of a user 2. The detection unit 11 can be an infrared (IR) sensor, a temperature sensor or a heartbeat sensor, and the detection unit 11 of this preferred embodiment is the infrared sensor. The setting unit 12 is provided for setting a first predetermined time 121. The waking unit 13 is provided for issuing a waking message 131.

The processing module 14 is electrically coupled to the detection unit 11, the setting unit 12 and the waking unit 13, wherein the processing module 14 can be a microprocessor control unit, a central processing unit or a micro-processing unit, and the processing module 14 of this preferred embodiment is the microprocessor. The processing module 14 can use the first predetermined time 121 as a base to retrieve a predetermined time interval 122 ahead in order to control the detection unit 11 to perform a detection, and the processing module 14 can timely analyze the motion 21 of the user 2 detected by the detection unit 11. The motion 21 refers a motion amplitude or a motion frequency. In the meantime, the processing module 14 can perform an analysis according to the motion 21 and a preset value 123. While the detection unit 11 detects that the motion 21 of the user 2 is greater than or equal to the preset value 123 during the predetermined time interval 122, the processing module 14 will control the waking unit 13 to issue a waking message 131. Wherein, the preset value 123 is a predetermined motion amplitude or motion frequency of the user 2, which is set by the setting unit. Wherein, the waking message 131 is a sound, a light, a vibration or their combinations.

Furthermore, after the user 2 sets the first predetermined time 121 through the setting unit 12, the processing module 14 can further control the detection unit 11 to test whether the motion 21 of the user 2 is detected normally. If the motion 21 of the user 2 cannot be detected normally, then the processing module 14 will control the waking unit 13 to issue a waking message 131 to remind the user 2.

It is noteworthy to point out that each of the units keep detecting the aforementioned motion 21 of the user 2 controlled by processing module 14 until the motion 21 is greater than or equal to the preset value 123 in the predetermined time interval 122, and the processing module 14 can control the waking unit 13 to issue a waking message 131. In addition, persons skilled in the art can combine any of the aforementioned functions into an integrated module or separate them into detailed units depending on the required design.

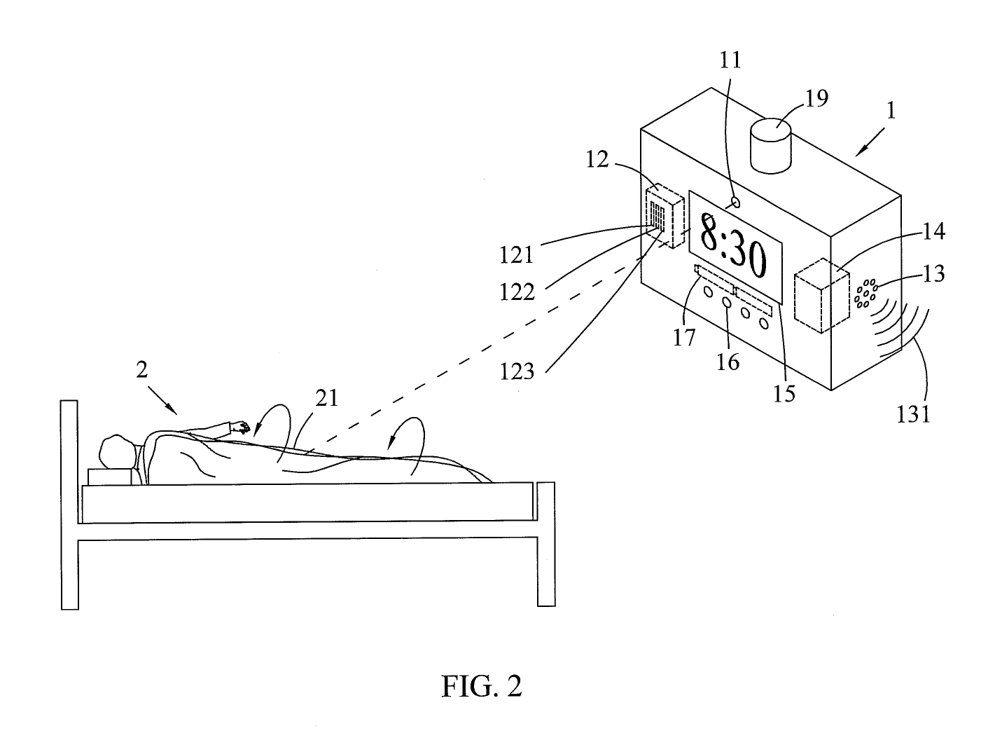

With reference to FIG. 2 for a schematic view of a smart waking device in accordance with the first preferred embodiment of the present invention, the smart waking device 2 further comprises a display unit 15, at least one press button 16 and an electric power unit 17. The display unit 15 and the press button 16 are electrically coupled to the setting unit 12. Wherein, the electric power unit 17 supplies an electric power required by the smart waking device 1, wherein the electric power unit 17 can be selected from a battery, a chargeable battery or a built-in micro chargeable lithium battery provided for the user 2 to change the battery when the battery level is low. If the user 2 wants to set the smart waking device 1, the user 2 can use the press button 16 to set the first predetermined time 121, the predetermined time interval 122 and the preset value 123, and the first predetermined time 121, the predetermined time interval 122 and the preset value 123 can be displayed from the display unit 15 and provided for the confirmation by the user 2. Wherein, the predetermined time interval 122 and the preset value 123 can be an appropriate constant such as a factory setting.

After the user 2 completes the setup. The processing module 14 further controls the detection unit 11 to test whether the motion 21 of the user 2 is detected normally. If the motion 21 of the user 2 cannot be detected normally, then the processing module 14 will control the waking unit 13 to issue a waking message 131 to remind the user 2 to set the foregoing parameters again or remind the user 2 about the disposing position of the smart waking device 2 to facilitate carrying out the detection by the detection unit 11. For example, after the user 2 completes the setting, the smart waking device 2 will test whether a normal test can be performed within 3 minutes. Wherein, the motion 21 of the user 2 can be a motion amplitude or a motion frequency, and the motion 21 of this preferred embodiment is the motion amplitude.

After the test is completed, the processing module 14 can use the first predetermined time 121 as a base to retrieve a predetermined time interval 122 ahead to control the detection unit 11 to carry out the detection. In the detection, the processing module 14 can timely analyze the motion 21 of the user 2 detected by the detection unit 11 and the preset value 123. While the detected motion 21 of the user 2 is greater than or equal to preset value 123, the processing module 14 will control the waking unit 13 to issue a waking message 131, and then the user 2 uses a stop switch 19 to stop the waking message 131. For example, the user 2 sets the first predetermined time to 8:30, and the processing module 14 controls the detection unit 11 to carry out the detection at 8 o'clock. If the detection unit 11 detects the motion 21 of the user 2 between 8 o'clock and 8:30, then the processing module 14 will control the waking unit 13 to issue a waking message 131 (such as sound). Further, if the detection unit 11 does not detect the motion 21 of the user 2 between 8 o'clock and 8:30, then each of units will continue detecting till 8:30, and the processing module 14 will control the waking unit 13 to issue a waking message 131 (which is a sound). Wherein, the waking message 131 is a sound, a light, a vibration or their combinations, and the waking message 131 of this preferred embodiment is the sound.

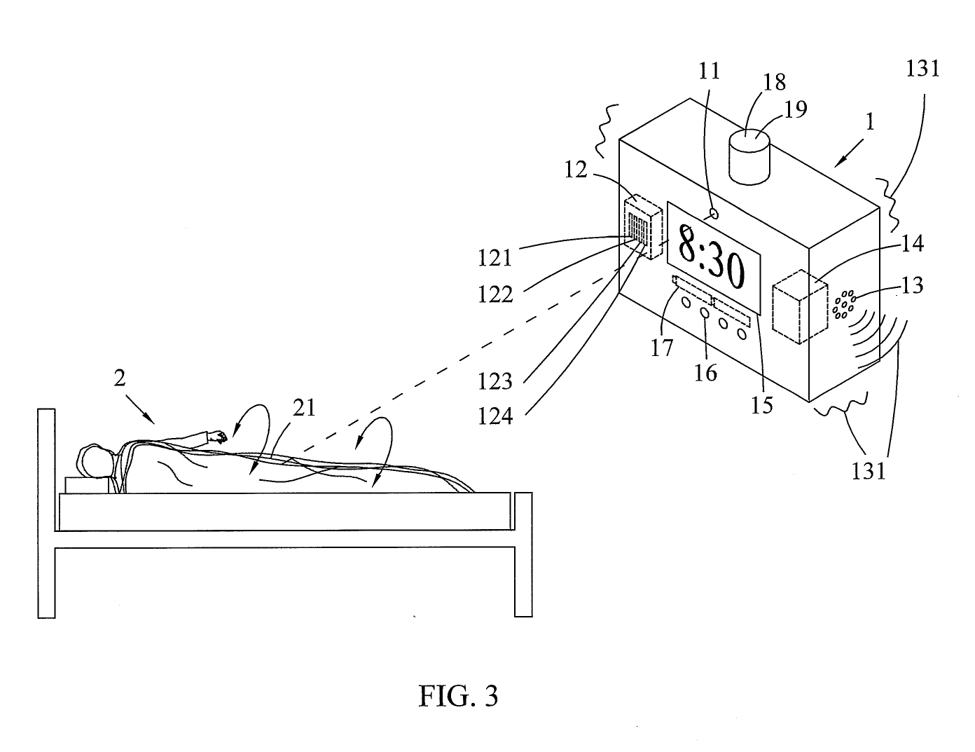

With reference to FIG. 3 for a schematic view of a smart waking device in accordance with the second preferred embodiment of the present invention, while the user 2 wants to set the smart waking device 1, the user can use the press button 16 to set the first predetermined time 121, the predetermined time interval 122 and the preset value 123, and the first predetermined time 121, the predetermined time interval 122 and the preset value 123 can be displayed from the display unit 15 and provided for confirmations by the user 2.

After the user 2 has completed the setting, the processing module 14 further controls the detection unit 11 to test whether the motion 21 of the user 2 is detected normally. If the motion 21 of the user 2 cannot be detected normally, then the processing module 14 will control the waking unit 13 to issue a waking message 131 to remind the user 2 to set the aforementioned parameters again, or remind the user 2 about the disposing position of the smart waking device 2 to facilitate the detection carried out by the detection unit 11. Wherein, the motion 21 of the user 2 can be a motion amplitude or a motion frequency, and the motion 21 is the motion frequency in this preferred embodiment.

After the test is completed, the processing module 14 can use the first predetermined time 121 as a base to retrieve a predetermined time interval 122 ahead to control the detection unit 11 to carry out the detection. In the detection, the processing module 14 can timely analyze the motion 21 of the user 2 detected by the detection unit 11 and the preset value 123. While the detected motion 21 of the user 2 is greater than or equal to preset value 123, then the processing module 14 will control the waking unit 13 to issue a waking message 131. Wherein, the waking message 131 can be a sound, a light, a vibration or their combinations, and the waking message 131 of this preferred embodiment is the combination of sound and vibration.

Wherein, the smart waking device further comprises a snooze switch 18 and a stop switch 19. The snooze switch 18 and the stop switch 19 are electrically coupled to the processing module 14. In this preferred embodiment, the snooze switch 18 and the stop switch 19 are integrated into a component which can be operated by pressing the component once for the function of the snooze switch 18, and pressing the component for more than once for the function of the stop switch 19, but such operation is provided for the illustration purpose only, and it can be changed or modified according to the actual design requirements. The snooze switch 18 is provided for the user 2 to set the processing module 14 to control the waking unit 13 to pause issuing a waking message 131 to a second predetermined time 124 depending on the spiritual and physical conditions of the user 2, and then the waking unit 13 continues to issue a waking message 131. The stop switch 19 is provided for the user 2 to control the processing module 14 so as to stop the waking unit 13 to issue a waking message 131. For example, the user presses the switch once for the function of the snooze switch 18, then the waking message 131 is stopped for 5 minutes, and then the waking unit 13 continues for issuing a waking message 131. Now, the user 2 presses the switch for several times for the function of the stop switch 19. However, the invention is not limited to such arrangement only.

In this preferred embodiment, besides the foregoing description, the rest is similar to the first preferred embodiment, and thus will not be described here again.

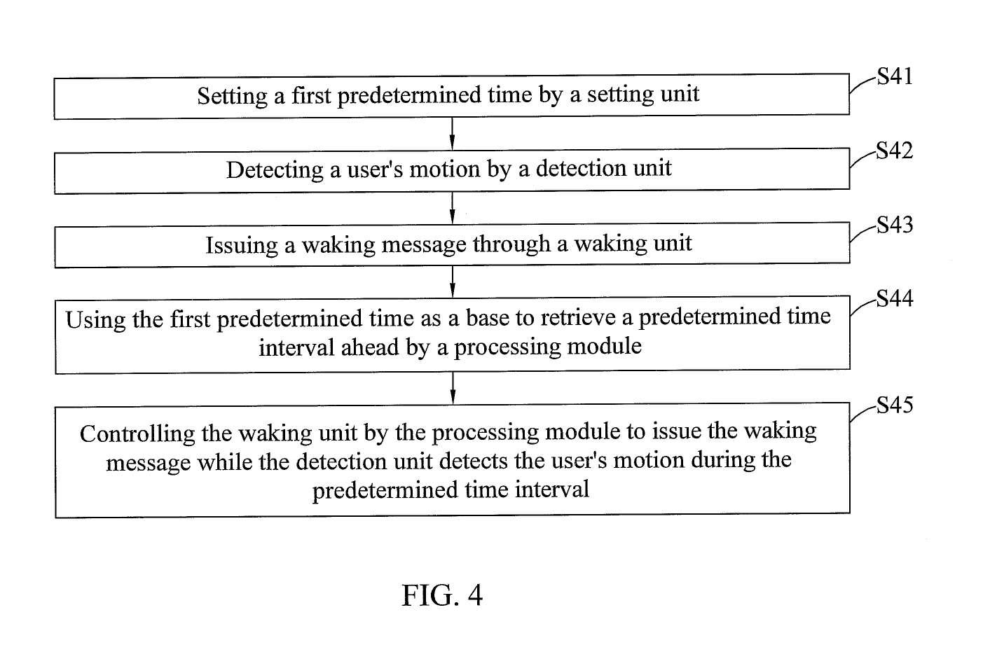

With reference to FIG. 4 for a schematic view of the procedure of the smart waking method of the present invention, the smart waking method involves a detection unit, a setting unit, a waking unit and a processing module, and the smart waking method comprises the following steps:

S41: Setting a first predetermined time by a setting unit.

S42: Detecting a user's motion by a detection unit.

S43: Issuing a waking message through a waking unit.

S44: Using the first predetermined time as a base to retrieve a predetermined time interval ahead by a processing module; and

S45: Controlling the waking unit by the processing module to issue the waking message while the detection unit detects the user's motion during the predetermined time interval.

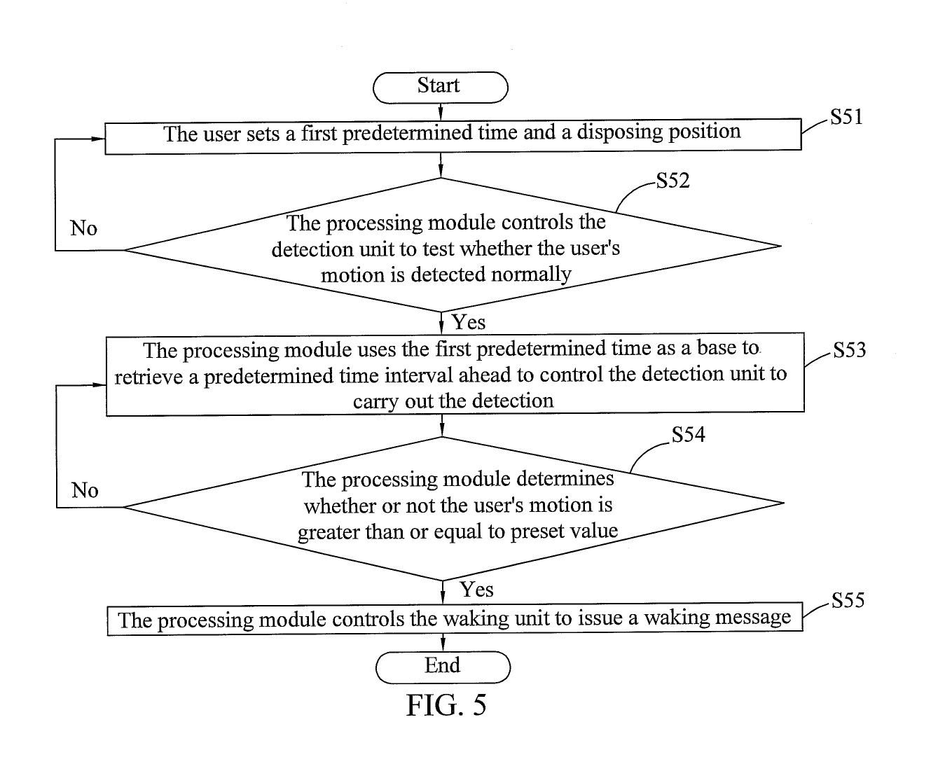

With reference to FIG. 5 for the flow chart of the smart waking method of the present invention, (S51): The user sets a first predetermined time and a disposing position. (S52) The processing module controls the detection unit to test whether the user's motion is detected normally (S53): The processing module uses the first predetermined time as a base to retrieve a predetermined time interval ahead to control the detection unit to carry out the detection. (S54) The processing module determines whether or not the user's motion is greater than or equal to preset value; if yes, go to (S55), or else go to (S54).

S55: The processing module controls the waking unit to issue a waking message.

The detailed description and implementation of the smart waking method of the present invention have already been described in the aforementioned description of the smart waking device of the present invention, and thus will not be described again here.

In summation of the description above, most users have a motion during their sleep can be regard as in a light sleep condition, and the smart waking device and method can detect the user's motion during the predetermined time interval by the detection unit, so as to wake a user, and the present invention can improve quality of the user's soberness and enhance the user's life quality.

The present invention has been described with some preferred embodiments thereof and it is understood that many changes and modifications in the described embodiments can be carried out without departing from the scope and the spirit of the invention that is intended to be limited only by the appended claims.

processing module controls the waking unit to issue the waking message.

What is claimed is:

1. A smart waking device, comprising:
a detection unit detecting a user's motion;
a setting unit setting a first predetermined time;
a waking unit issuing a waking message; and
a processing module electrically coupled to the detection unit, the setting unit and the waking unit, and the processing module using the first predetermined time as a base to retrieve a predetermined time interval ahead, wherein if the detection unit detects the user's motion during the predetermined time interval, the processing module controls the waking unit to issue the waking message.

2. The smart waking device of claim 1, wherein after the setting unit sets the first predetermined time, the processing module controls the detection unit to test whether the user's motion is detected normally.

3. The smart waking device of claim 1, wherein if the detection unit detects that a motion amplitude or a motion frequency of the user is greater than or equal to a preset value during the predetermined time interval, the processing module controls the waking unit to issue the waking message.

4. The smart waking device of claim 3, wherein the setting unit further sets the preset value.

5. The smart waking device of claim 3, further comprising a display unit displaying the first predetermined time, the predetermined time interval and the preset value.

6. The smart waking device of claim 3, further comprising at least one press button setting the first predetermined time, the predetermined time interval and the preset value in the setting unit.

7. The smart waking device of claim 1, wherein the waking message is a sound, a light, a vibration or combinations thereof.

8. The smart waking device of claim 1, further comprising an electric power unit supplying electric power required by the smart waking device.

9. The smart waking device of claim 1, further comprising a snooze switch provided for the user to pause the waking message for a second predetermined time, and then the waking unit issuing the waking message again.

10. The smart waking device of claim 1, further comprising a stop switch provided for the user to stop the waking unit issuing the waking message.

11. A smart waking method, comprising the steps of:
setting a first predetermined time by a setting unit;
detecting a user's motion by using a detection unit;
issuing a waking message through a waking unit;
using the first predetermined time as a base by a processing module to retrieve a predetermined time interval ahead; and
controlling the waking unit by the processing module to issue the waking message while the detection unit detects the user's motion during the predetermined time interval.

12. The smart waking method of claim 11, further comprising the step of controlling the detection unit by the processing module to test whether the user's motion is detected normally, after setting the first predetermined time by the setting unit.

13. The smart waking method of claim 11, further comprising the step of:
while the detection unit detects that the motion amplitude or the motion frequency of the user is greater than or equal to a preset value during the predetermined time interval, the processing module controls the waking unit to issue the waking message.

14. The smart waking method of claim 13, further comprising the step of setting the preset value by the setting unit.

15. The smart waking method of claim 13, further comprising the step of setting the first predetermined time, the predetermined time interval and the preset value in the setting unit by at least one press button.
